(19) United States
(12) Patent Application Publication
(10) Pub. No.: US 2007/0267521 A1
(43) Pub. Date: Nov. 22, 2007

(54) Automatic Elevating Shower or Faucet

(76) Inventor: Huasong ZHOU, Xiamen (CN)

Correspondence Address: BANGER SHIA, 204 CANYON CREEK, VICTORIA, TX, 77901-3695, US

(21) Appl. No.: 11/419,494

(22) Filed: May 20, 2006

(51) Int. Cl. B05B 1/32; B05B 1/30

(52) U.S. Cl. 239/451; 239/569; 239/456

(57) ABSTRACT

The present invention provides an automatic elevating device for shower or faucet, which is typically comprised of a hydraulic cylinders, pistons, push rods and valves; there are two ports built on the both ends of said hydraulic cylinder for attaching a valve on each, said piston is set upon the inside between the both ports of said hydraulic cylinder in motion fit, said push rod is fixed on said piston with one end, and another end is stretched out of the hydraulic cylinder, said shower head or faucet is mounted on the push rod, and said hydraulic cylinder is mounted on a static place, said valves are used for controlling on port of the hydraulic cylinder entering water and another port draining water so as to control said hydraulic cylinder elevating motion, or closes the both ports of the hydraulic cylinder to stop the hydraulic cylinder motion. Said device can be used in shower or faucet beyond sink, if a shower head or the whole shower is mounted on the push rods, by means of the hydraulic cylinders, the shower head can be lifted automatically up or withdrew down automatically for facilitating to use with better showering effect, or taking the push rod as the supply pipe, by means of the hydraulic cylinders, the faucet can be elevated up or withdrew down automatically, so as to be hidden under the working top in the idle time, only lifted out in use time to save space efficiently.

### BACKGROUND OF THE INVENTION

1. Field of the Invention

The present invention relates to an elevating device, and more particularly to an automatic elevating used on a shower or a faucet.

2. Description of Prior Art

In accordance with the conventional technology, the most of the conventional showers have three spraying nozzles, like head, side and hand-hold nozzles. But after mounted on the wall, the head and side nozzles are unable to be adjusted in height, so as not to meet the necessary of different high users especially to super-elevation users, further to affecting the showering effect. If washing any portion of body, just only use hand-hold shower head, so that one head has to be occupied in operation, it is inconvenient to user, meanwhile the showering effect is also affected.

On the other hand, in accordance with the conventional technology, the most of the structure of the faucet located on the side of the kitchen sink occupies big space, especially nearing the window, even affect to open the window.

This is the sake of discovering the present invention. The inventor try to provide an elevating device used for a shower or a faucet overcoming the shortcomings mentioned above, which can be hidden in idle time for saving occupied space, but it can lift out in use time automatically.

### OBJECTS AND SUMMARY OF THE INVENTION

It is therefore a main object of the present invention to provide an automatic elevating device used for shower or faucet facilitating to elevating shower head in use with good showering effect, or hiding faucet under the working top in the idle time, only lift it out in use time so as to save space efficiently.

For achieving the above-mentioned object, the present invention provides an automatic elevating device for shower or faucet that is typically comprised of a hydraulic cylinders, pistons, push rods and valves; there are two ports built on the both ends of said hydraulic cylinder for attaching a valve on each, said piston is set upon the inside between the both ports of said hydraulic cylinder in motion fit, said push rod is fixed on said piston with one end, and another end is stretched out of the hydraulic cylinder, said shower head or faucet is mounted on the push rod, and said hydraulic cylinder is mounted on a static place, said valves are used for controlling on port of the hydraulic cylinder entering water and another port draining water so as to control said hydraulic cylinder elevating motion, or closes the both ports of the hydraulic cylinder to stop the hydraulic cylinder motion.

Said hydraulic cylinder set is mounted on the wall vertically, in one set at least there are two parallel hydraulic cylinders included, on each cylinder there are two ports built on the both ends respectively, the top ports of all cylinders are connected together and led out an upper port, in the same way, the bottom ports are connected together and led out a low port, and said upper and low ports are attached with a valve on each; the whole shower set is mounted on the push rods, and the number of the push rods is as same as the cylinder's.

Said push rods works as an elevating rod of shower, the shower head of the shower is hung on the elevating rod via a shower head holder; said hydraulic cylinders are mounted on the main body of the shower vertically.

Said hydraulic cylinders are vertically mounted under the working top, said push rods are used also as supply pipes, the both ends of the push rod are stretched out from the both ends of the cylinder respectively.

There is a valve attached on each port of the hydraulic cylinder.

There is a valve connected to the both ports of the hydraulic cylinder for controlling the two ports one entering water and another draining water, or both ports closed in three stage control function.

An automatic elevating device for shower or faucet is typically comprised of pneumatic cylinders, pistons, push rods and valves, wherein said pneumatic cylinder is possessed of two ports built on the both ends respectively connecting to valves, said piston is set upon the inside between the both ports of said hydraulic cylinder in motion fit, said push rod is fixed on said piston with one end, and another end is stretched out of the pneumatic cylinder, said shower head or faucet is mounted on the push rods, and said pneumatic cylinders are mounted on a static place, said valves are used for controlling on port of the pneumatic cylinder entering water and another port draining water so as to control said pneumatic cylinder elevating motion, or closes the both ports of the pneumatic cylinder to stop the hydraulic cylinder motion.

As utilizing above-mentioned project, when tending to use the present invention in a shower set or faucet, by controlling the valve, to control one port of the hydraulic cylinder entering water, meanwhile the another port draining water brings the push rod to going up or down, or both ports of the hydraulic cylinder closing brings the push rod to stopping motion, in this way, when tending to make the elevating component go up, such as shower head is mounted on the push rod, by means of the hydraulic cylinders, the shower head can be lifted automatically up or withdrew down, or the whole shower set is mounted on the push rods, by means of the hydraulic cylinders, the whole shower set can be lifted up or withdrew down automatically for facilitating to use with better showering effect, or taking the push rod as the supply pipe, by means of the hydraulic cylinders, the faucet can be elevated up or withdrew down automatically, so as to be hidden under the working top in the idle time, only lifted out in use time to save space efficiently.

If pneumatic cylinder is took the place of the hydraulic cylinder, in the same principle, so here will not described again.

### BRIEF DESCRIPTION OF THE DRAWINGS

FIG. 1 is a front side sectional view showing the first embodiment in elevating state of the present invention.

FIG. 2 is a front side sectional view showing the falling state of FIG. 1.

FIG. 3 is a front side sectional side view showing the second embodiment in elevating state of the present invention.

FIG. 4 is a front side sectional view showing the falling state of FIG. 3.

FIG. 5 is a cross-section view showing the third embodiment in lifting state of present invention.

FIG. 6 is a cross-section view showing the falling state of FIG. 5.

FIG. 7 is a cross-section view showing the locating state of FIG. 6.

### DETAILED DESCRIPTION OF PREFERRED EMBODIMENTS

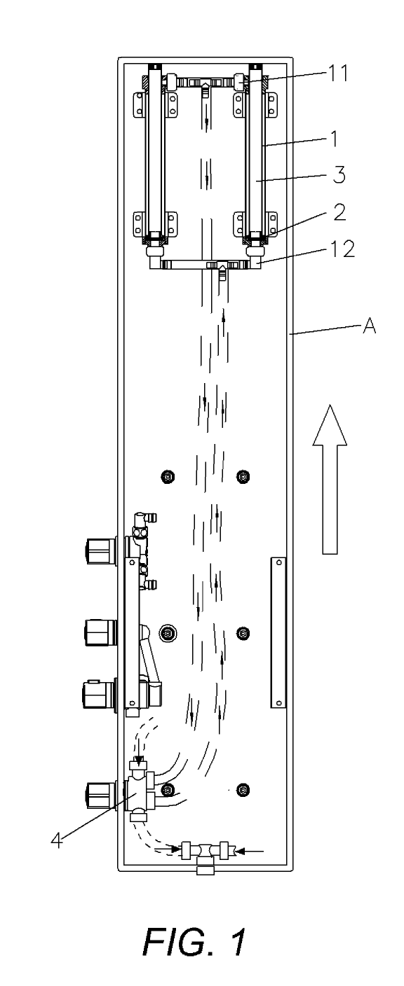

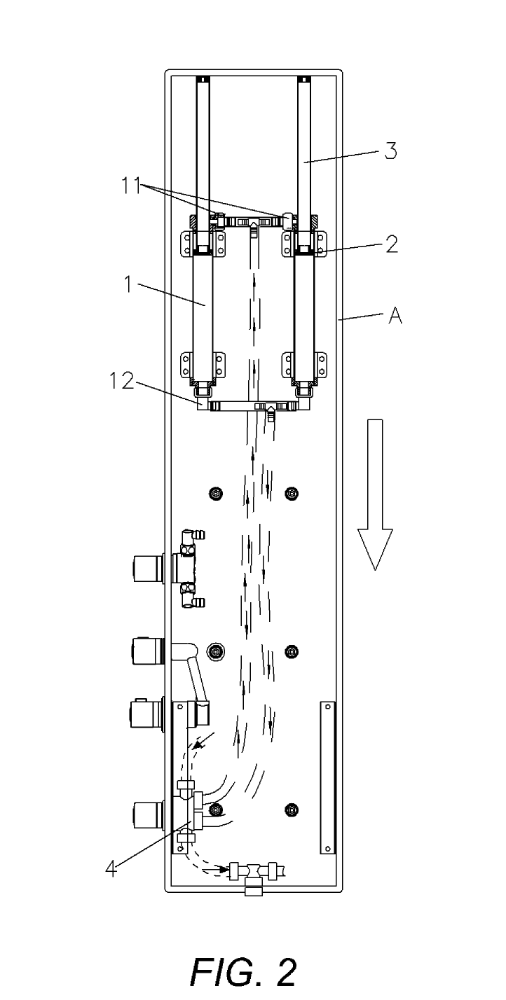

Referring to FIG. 1 and FIG. 2, an automatic elevating device for shower or faucet discovered by the present invention is typically comprised of hydraulic cylinders 1, pistons 2, push rods 3 and valves 4.

Wherein, said hydraulic cylinder 1 is possessed of two ports 11 12 built upon the both ends respectively.

Said piston 2 is set upon the inside between the both ports of said hydraulic cylinder in motion fit.

Said push rod 3 is fixed on the piston 3, said hydraulic cylinder 1 is mounted on a relative static place, in this embodiment, and said hydraulic cylinder 1 is mounted on the wall vertically. For keeping the whole shower set A moving smoothly in elevating motion, in this embodiment, in one set A at least there are two parallel hydraulic cylinders 1 included (the number of the hydraulic cylinder is not limited here, but the prefer choice is two hydraulic cylinders 1), on each cylinder 1 there are two ports 11 12 built on the both ends respectively, the top ports 11 of all cylinders are connected together and led out a common upper port, in the same way, the low ports 12 are connected together and led out a common low port, and the number of the push rods 3 is as same as the cylinder's.

Said upper and low ports 11 12 are attached with a valve 4 on each. Said valve 4 is attached on the upper port 11 or low port 12 separately, on the other hand, as illustrated in the first embodiment, all the upper and low ports 11 12 also can be connected to an integrated valve 4 for controlling one port of the two ports entering water and another port draining water, or all ports closing in three stage controlling function.

In practice, whatever the structure of the valve 4 is, it can control a port entering water, meanwhile another port draining water, cooperating to FIG. 1 and FIG. 2, to bring the piston 2 to drive the push rod 3 going up or down, so as to make the whole shower set A go up or down (as shown in FIG. 1 and FIG. 2), or close all ports of the hydraulic cylinder 1 to stop the push rod 3 moving (not shown in drawings) for locating the whole shower set A in a certain height facilitating to using with better showering effect.

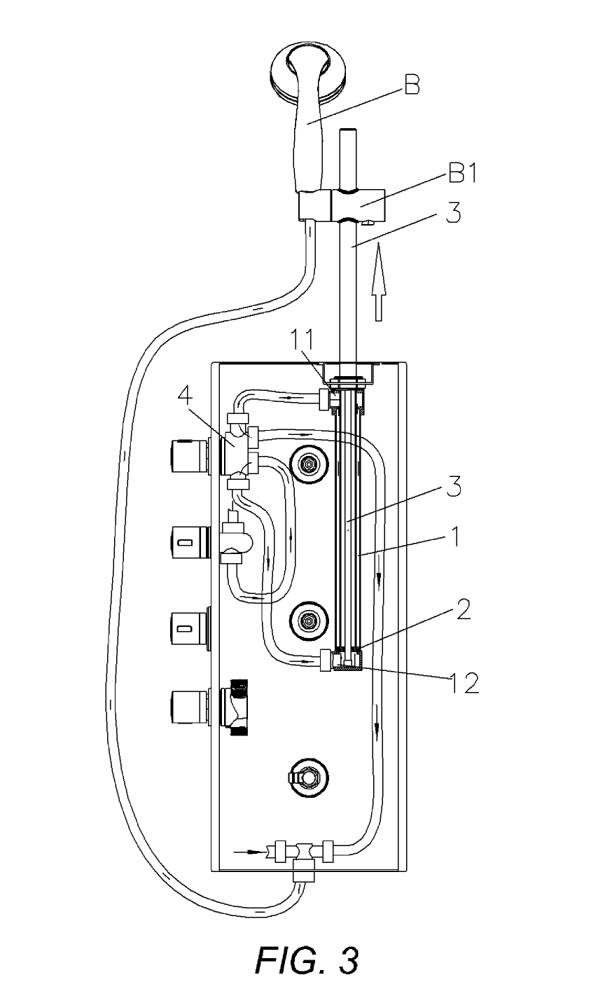

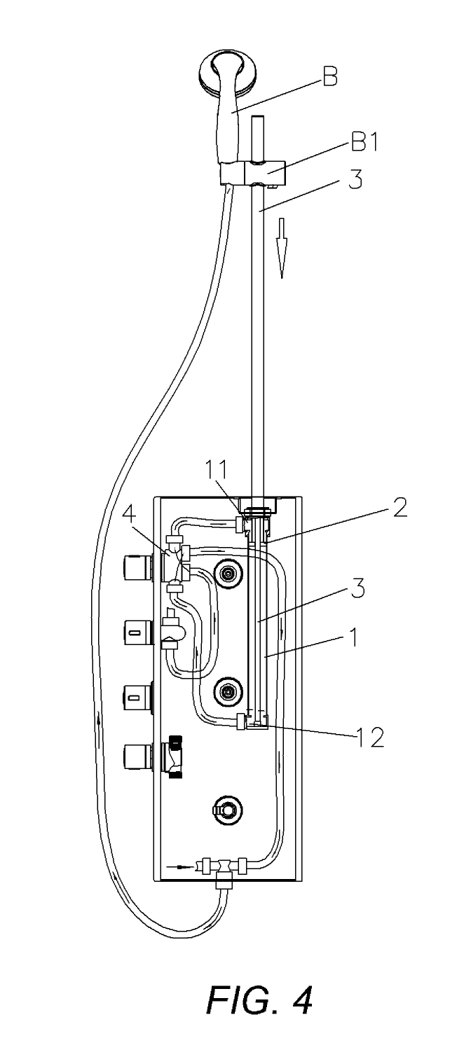

Referring to FIG. 3 and FIG. 4, the second embodiment of the present invention is illustrated, which used in shower is typically comprised of hydraulic cylinders 1, pistons 2, push rods 3 and valves 4.

Wherein, said hydraulic cylinder 1 is possessed of two ports 11 12 built upon the both ends respectively.

Said piston 2 is set upon the inside between the both ports of said hydraulic cylinder in motion fit.

Said push rod 3 is taken as an elevating rod, and is fixed on the piston 3 with one end, and the another end is stretched out from the hydraulic cylinder 1.

Said shower head B of the shower is located on the elevating rod via a shower head holder B1. Said hydraulic cylinders 1 are mounted on the relative static place, in the second embodiment they are mounted on the shower set parallelly and vertically.

Said upper and low ports 11 12 are attached with a valve 4 on each. Said valve 4 is attached on the upper port 11 or low port 12 separately, on the other hand, as illustrated in the second embodiment, all the upper and low ports 11 12 also can be connected to an integrated valve 4 for controlling one port of the two ports entering water and another port draining water, or all ports closing in three stage controlling function.

In practice, whatever the structure of the valve 4 is, it can control a port entering water, meanwhile another port draining water, cooperating to FIG. 3 and FIG. 4, to bring the piston 2 to drive the push rod 3 going up or down, so as to make the shower head B go up or down (as shown in FIG. 3 and FIG. 4), or close all ports of the hydraulic cylinder 1 to stop the push rod 3 moving (not shown in drawings) for locating the shower head B in a certain height facilitating to using with better showering effect.

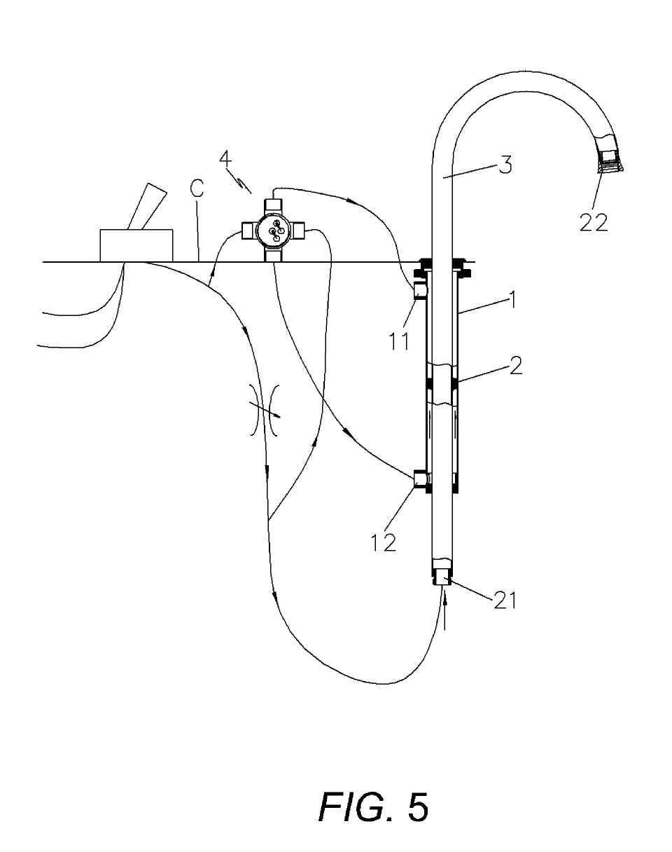

Referring to FIG. 5 to FIG. 7, the third embodiment of the present invention is illustrated, which used in faucet beyond a sink is typically comprised of hydraulic cylinders 1, pistons 2, push rods 3 and valves 4.

Wherein, said hydraulic cylinder 1 is possessed of two ports 11 12 built upon the both ends respectively.

Said piston 2 is set upon the inside between the both ports of said hydraulic cylinder in motion fit.

Said push rod 3 also can be the supply pipe, and is fixed on the piston 3 with the trunk, and the both ends are stretched out from the hydraulic cylinder 1 respectively.

Said hydraulic cylinders 1 are mounted on the relative static place, in the third embodiment they are mounted under the working top of the sink parallelly and vertically.

Said upper and low ports 11 12 are attached with a valve 4 on each. Said valve 4 is attached on the upper port 11 or low port 12 separately, on the other hand, as illustrated in the third embodiment, all the upper and low ports 11 12 also can be connected to an integrated valve 4 for controlling one port of the two ports entering water and another port draining water, or all ports closing in three stage controlling function.

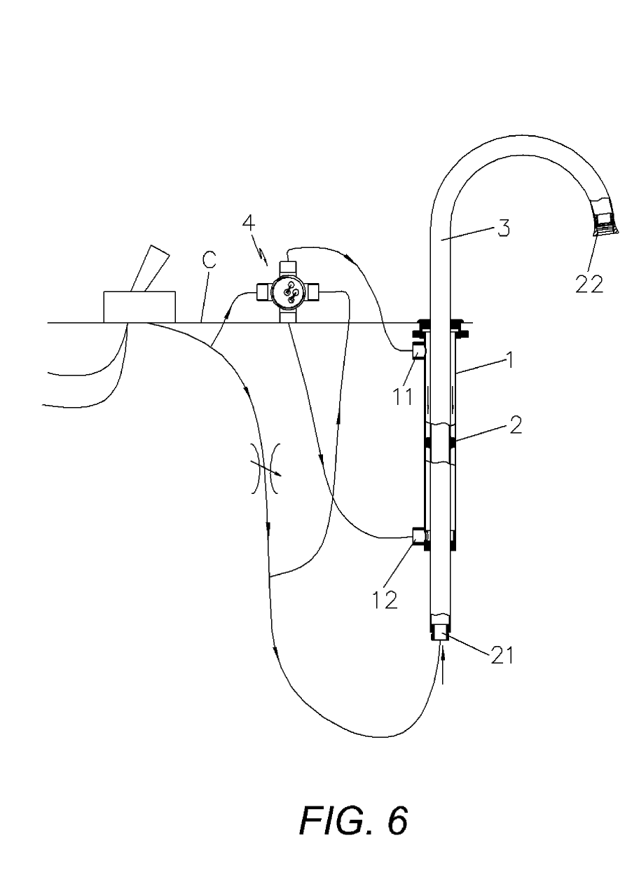

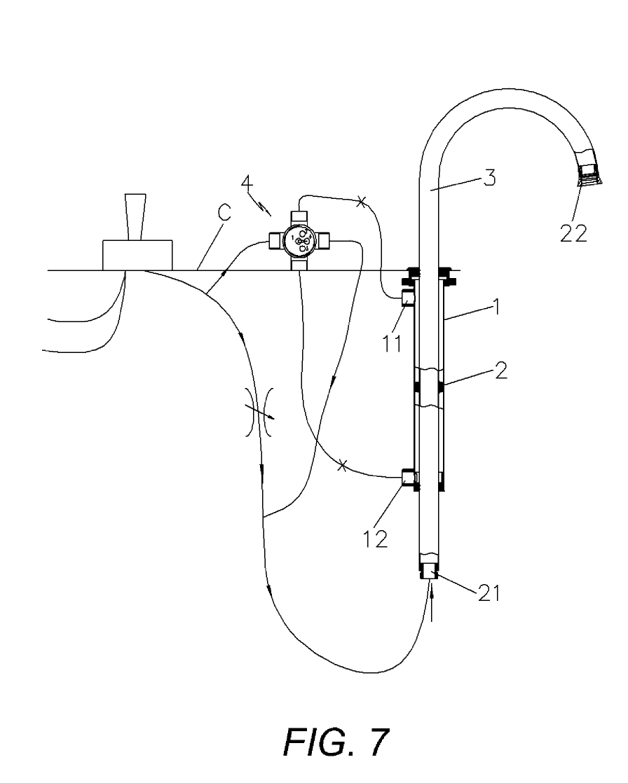

In practice, whatever the structure of the valve 4 is, it can control a port entering water, meanwhile another port draining water, cooperating to FIG. 5 and FIG. 6, to bring the piston 2 to drive the push rod 3 going up or down, so as to make the faucet go up or down (as shown in FIG. 5 and FIG. 6), in order to lift the faucet up above the working top C in using time, and hide below the working top C in the idle time for saving space; or close all ports of the hydraulic cylinder 1 to stop the push rod 3 moving, as shown in FIG. 7, for locating the faucet in a certain height facilitating to using with better showering effect.

I claim:

1. An automatic elevating device for shower or faucet typically comprised of a hydraulic cylinders, pistons, push rods and valves; there are two ports built on the both ends of said hydraulic cylinder for attaching a valve on each, said piston is set upon the inside between the both ports of said hydraulic cylinder in motion fit, said push rod is fixed on said piston with one end, and another end is stretched out of the hydraulic cylinder, said shower head or faucet is mounted on the push rod, and said hydraulic cylinder is mounted on a static place, said valves are used for controlling on port of the hydraulic cylinder entering water and another port draining water so as to control said hydraulic cylinder elevating motion, or closes the both ports of the hydraulic cylinder to stop the hydraulic cylinder motion.

2. An automatic elevating device for shower or faucet as claimed in claim 1, wherein said hydraulic cylinder set is mounted on the wall vertically, in one set at least there are two parallel hydraulic cylinders included, on each cylinder there are two ports built on the both ends respectively, the top ports of all cylinders are connected together and led out an upper port, in the same way, the bottom ports are connected together and led out a low port, and said upper and low ports are attached with a valve on each; the whole shower set is mounted on the push rods, and the number of the push rods is as same as the cylinder's.

3. An automatic elevating device for shower or faucet as claimed in claim 1, wherein said push rods works as an elevating rod of shower, the shower head of the shower is hung on the elevating rod via a shower head holder; said hydraulic cylinders are mounted on the main body of the shower vertically.

4. An automatic elevating device for shower or faucet as claimed in claim 1, wherein said hydraulic cylinders are vertically mounted under the working top, said push rods are used also as supply pipes; the both ends of the push rod are stretched out from the both ends of the cylinder respectively.

5. An automatic elevating device for shower or faucet as claimed in claim 1, wherein there is a valve attached on each port of the hydraulic cylinder.

6. An automatic elevating device for shower or faucet as claimed in claim 1, wherein there is a valve connected to the both ports of the hydraulic cylinder for controlling the two ports one port entering water and another port draining water, or both ports closed in three stage control function.

7. An automatic elevating device for shower or faucet is typically comprised of pneumatic cylinders, pistons, push rods and valves, wherein said pneumatic cylinder is possessed of two ports built on the both ends respectively connecting to valves, said piston is set upon the inside between the both ports of said hydraulic cylinder in motion fit, said push rod is fixed on said piston with one end, and another end is stretched out of the pneumatic cylinder, said shower head or faucet is mounted on the push rods, and said pneumatic cylinders are mounted on a static place, said valves are used for controlling on port of the pneumatic cylinder entering water and another port draining water so as to control said pneumatic cylinder elevating motion, or closes the both ports of the pneumatic cylinder to stop the hydraulic cylinder motion.
